(19) United States
(12) Patent Application Publication
(10) Pub. No.: US 2007/0143946 A1
(43) Pub. Date: Jun. 28, 2007

(54) Multi paint roller connector

(76) Inventor: Song Kim, Palos Verdes Estates, CA (US)

Correspondence Address: Robert Berliner;FULBRIGHT & JAWORSKI, L.L.P., Forty-First Floor, 555 South Flower Street, Los Angeles, CA, 90071, US

(21) Appl. No.: 11/319,296

(22) Filed: Dec. 27, 2005

(51) Int. Cl. B05C 17/02

(52) U.S. Cl. 15/230.11; 492/13; 492/19

(57) ABSTRACT

A bracket for mounting one or more paint rollers to the shaft of a paint roller frame. A mounting plate carries a pair of roller engaging members extending normal to the mounting plate on opposite ends thereof, each roller engaging member being formed to rollingly engage an end of a paint roller. A shaft engaging member is located between the pair of roller engaging members and has a shaft opening formed there through of a dimension, and arranged, to pivotally receive the shaft of a paint roller frame. In one embodiment, one or more mini-rollers, with internal roller bearings, are carried on shafts integral with and extending from opposing mounting brackets. In other embodiments, two or three standard paint rollers are carried on members that extend from opposing mounting brackets and are rotatable thereon. In further embodiments, a first roller is formed with a surface material that has sufficient nap or a sufficiently low density or porosity to carry an amount of paint sufficient to cover a desired area of surface to be painted, and a second roller is formed with a surface material of a sufficiently high density to provide a smooth finish to said surface area.

### FIELD OF THE INVENTION

The present invention relates generally to an apparatus for painting and in particular to a mounting bracket for paint rollers.

### BACKGROUND OF THE INVENTION

A variety of paint roller assemblies are available, typically comprising a handle carrying a frame, usually of metal, pivotally connected to a paint roller for applying paint to a surface. Many of these paint roller assemblies include a single paint roller, others include a plurality of paint rollers for purposes of reducing the number of strokes required to cover a surface of paint, for catching dripping paint on to a secondary roller, to transfer paint from one roller to another, for example, stencil, paint roller, and the like. Representative prior art includes United States Patent Publication Nos. 2005/0091778, entitled “Paint Roller Assembly,” 2002/0122893, entitled “Dual Spindle Paint Roller,” and U.S. Pat. No. 6,045,282 entitled “Multi-Roller Paint Applicator System,” U.S. Pat. No. 6,219,877 entitled “Pivotal and Pivotal Adjustable Dual Roller Paint Frames,” U.S. Pat. No. 5,967,041 entitled “Dual Roller Stencil Applicator,” U.S. Pat. No. 5,857,795 entitled “Paint Roller Device,” U.S. Pat. No. 5,713,095 entitled “Bifurcated Paint Roller and Painting Method,” U.S. Pat. No. 5,702,525 entitled “Paint Roller Device,” U.S. Pat. No. 5,386,611 entitled “Paint Roller,” U.S. Pat. No. 5,386,610 entitled “Multiple Roller Edger,” U.S. Pat. No. 4,320,553 entitled “Paint Roller Assembly,” U.S. Pat. No. 4,198,723 entitled “Multi-Element Paint Roller,” and U.S. Pat. No. 4,000,537, entitled “Paint Roller Device Having Juxta-Posed Rollers.” Each of the foregoing patent and patent publication are incorporated herein by reference.

While a wide variety of structures are provided by the foregoing prior art, and some of them are fairly simple in structure, none provide a completely satisfactory solution to the economics of paint roller manufacture which requires not only low cost but also effective and secure construction that can be used with a widely available commercial paint rollers. In this regard, a widely available “standard” size paint roller comprises a roller tube and a surfacing material disposed on the outer surface of the roller tube for carrying paint or the like. One example of such a roller is shown in U.S. Pat. No. 6,941,609, entitled “Paint Roller Assembly,” the disclosure of which is incorporated herein by reference, and which describes a widely available paint roller.

Another form of paint roller which is quite popular can be called a mini-roller such as shown in U.S. Pat. No. 5,473,823 entitled “Mini-Roller Cleaning Tool,” the disclosure of which is incorporated herein by reference. Such a roller can be mounted on the wire frame shaft of a paint roller handle by means of a cylindrical roller bearing carried internally in each end of the mini-roller. Such a roller bearing, including a mounting cylinder therefor, is shown in U.S. Patent Application Publication No. 2004/0237241 entitled “Paint Roller Mounting Assembly,” the disclosure of which is incorporated herein by reference.

There are different rollers for different purposes. It is often desirable to use a high density foam roller to obtain a very smooth finish, but such rollers do not have the porosity to carry sufficient paint. To overcome this drawback, painters often use a fabric or low density, open cell foam roller to put paint on a smooth surface and then back roll the surface by using a high density foam roller to complete the job. Such a high density roller has about 50 to 64 Kg in weight per cubic meter. Material such as polyethylene ester foam of closed cell construction can be used, but one can use any other material that provides a smooth finish. It would be desirable to enable the use of a high density paint roller to provide a smoother finish while avoiding the need to double roll the surface.

### BRIEF SUMMARY OF THE INVENTION

The present invention provides an inexpensive but extremely effective bracket and bracket assembly capable of mounting a plurality of paint rollers to the shaft of a standard paint roller frame, but which can also be used to mount a single roller to the frame. This is accomplished by providing a simple mounting plate carrying a paint roller engaging member on opposite ends extending normal to the mounting plate. Each paint roller engaging member is formed to rollingly engage an end of a paint roller either directly or by means of a roller bearing carried internally on each end of a the paint roller. The bracket is provided with a member that engages the shaft end of the paint roller frame and is located between, preferably midway, the pair of paint roller engaging members. The shaft engaging member has a shaft opening formed there through of a dimension and a range to pivotally receive the shaft of a paint roller frame.

The roller engaging members are preferably cylindrical shafts formed integral with the mounting plate, each having an outer diameter substantially the same as the paint roller frame shaft. An assembly of opposing inexpensive polypropylene or other plastic brackets can thus be provided.

In one embodiment, particularly useful for mini-paint rollers, the cylindrical shafts are received by roller bearings carried internally on each end of the paint roller.

In another embodiment, generally useful for standard size paint rollers, the roller engaging members are rotatable on the mounting plate each having an outer diameter substantially the same as the inner diameter of a paint roller whereby to frictionally engage the inner surfaces of the paint roller.

In still another embodiment, the frame shaft engaging member located between the pair of roller engaging members in itself a roller engaging member that serves a dual purpose of engaging the frame shaft by means of a shaft opening formed there through, and additionally bearing a roller engaging member rotatable on the mounting plate and having an outer diameter substantially the same as the inner diameter of a paint roller whereby it frictionally engages the paint roller in the same manner as the end pairs of paint roller engaging members carried by the mounting plate.

The present invention responds to complaints often made by painters as single rollers do not carry enough paint, and time is wasted in dipping the paint rollers. This will benefit painters due to less dipping time and more painting time. Moreover, painters will save time with the use of multi-rollers because it will allow a larger surface to be painted than with a single roller.

Moreover, the present invention enables a painter to use a low density, or high porosity, paint roller and high density paint roller in one step, by providing a low density paint roller as one of the rollers and a high density paint roller as the other roller. This allows the painter to avoid double rolling the surface by carrying sufficient paint on the one roller to cover a desirable surface area and using the other, high density, roller to provide a very smooth finish.

Although the invention will be described with respect to its use with multi-paint rollers, it can be used with a single roller, preferably a mini-roller, on the same frame. Moreover, as will be shown in the description to follow, the bracket can be constructed to hold more than two rollers.

Features and advantages of the invention will be described hereinafter, which form the subject of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is a cross-sectional view of an assembly of a paint roller frame and two paint rollers formed using a pair of brackets in accordance with a first embodiment of this invention;

FIG. 2 is a side elevational view of the right side bracket shown in FIG. 1;

FIG. 3 is a front planar view of the bracket of FIG. 2;

FIG. 4 is a cross-sectional view of a paint roller containing shaft receiving roller bearings carried internally on each end thereof for use with the bracket of FIG. 2;

FIG. 5 is a cross-sectional view of an assembly of a pair of paint rollers of FIG. 4 connected by a pair of brackets of FIG. 2;

FIG. 6 is a cross-sectional view of an assembly of a paint roller frame and two paint rollers formed using a pair of brackets in accordance with a second embodiment of this invention;

FIG. 7 is a side elevational view of the right side bracket shown in FIG. 6;

FIG. 8 is a front planar view of the bracket of FIG. 7;

FIG. 9 is a cross-sectional view of a paint roller for use with the bracket of FIG. 7;

FIG. 10 is a cross-sectional view of an assembly of a pair of paint rollers of FIG. 9 connected by a pair of brackets of FIG. 7; and

FIG. 11 is a cross-sectional view of an assembly of a paint roller frame and three paint rollers formed using a pair of brackets in accordance with a third embodiment of this invention.

### DETAILED DESCRIPTION OF THE INVENTION

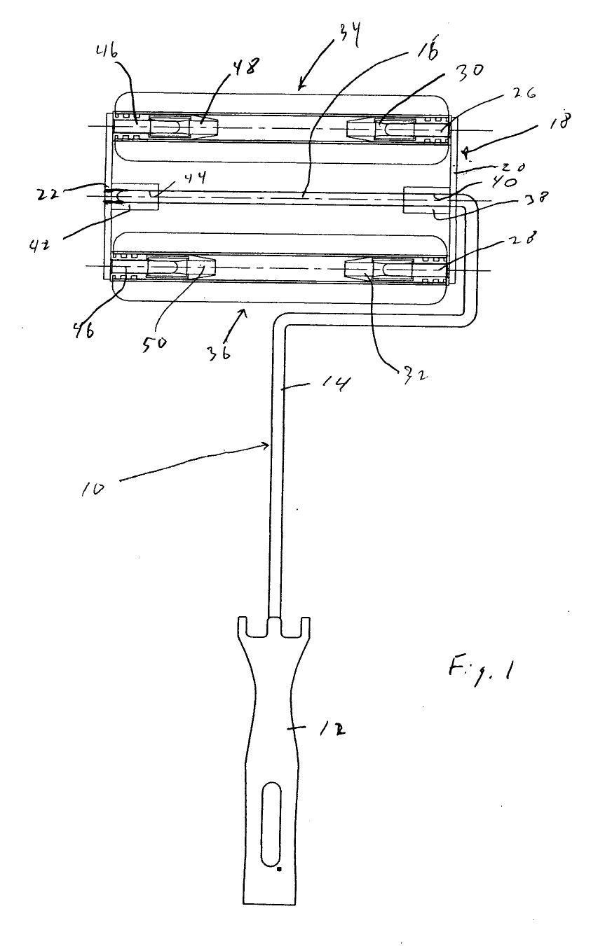

Referring to FIG. 1, an assembly is shown comprising a more or less standard type paint roller frame 10 consisting of a handle 12 carrying a wire frame 14 that is bent in return fashion and terminates with a shaft 16. The shaft 16 is connected to a bracket assembly 18 which consist of a proximal bracket 20 and a distal bracket 22.

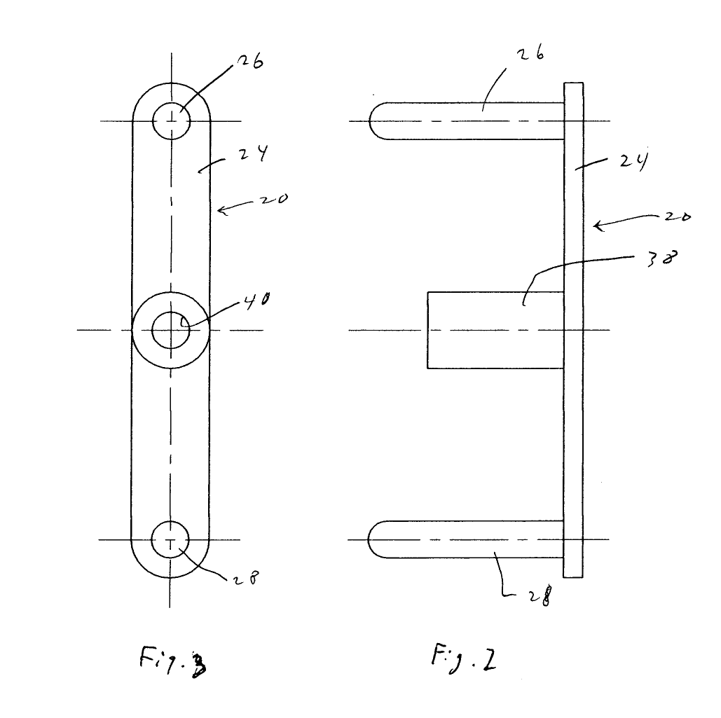

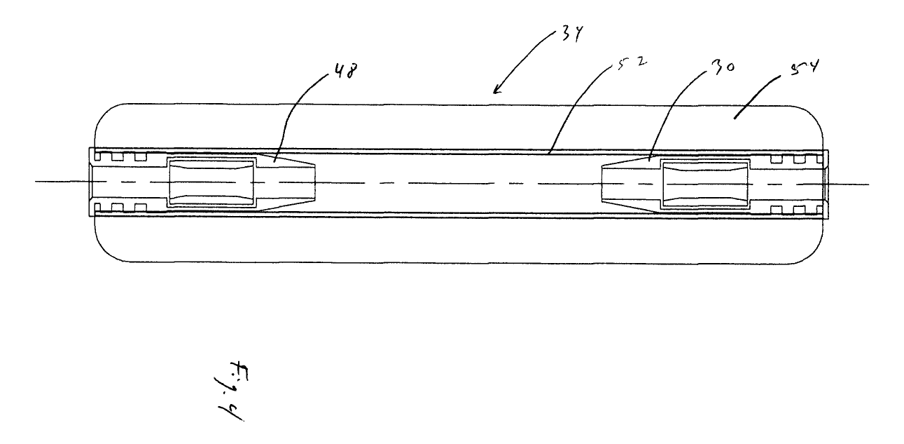

Referring additionally to FIGS. 2 and 3, the proximal bracket 20 consists of a mounting plate 24 and a pair of cylindrical roller engaging shafts 26 and 28 integral with and extending normal to the mounting plate 24 on opposite ends thereof. The roller engaging shafts 26 and 28 each has an outer diameter substantially the same as the diameter of the paint roller frame shaft 16. This enables it to engage shaft receiving roller bearings, respectively 30 and 32, carried internally on the ends of a pair of mini-rollers, respectively 34 and 36.

The proximal bracket 20 has a member 38 integral with and extending normal to the mounting plate 24, formed with an opening 40 of a dimension, and arranged, to pivotally receive the shaft 16 of the paint roller frame 14.

The distal bracket 22, shown in FIG. 1, has a construction identical to that of the proximal bracket shown in FIGS. 2 and 3. In a modification, the shaft receiving opening 40 in the proximal bracket 20 is formed entirely through the shaft receiving member 38, whereas in the distal bracket 22, the shaft receiving member 42 can have its opening 44 formed either through the shaft receiving member 42 or the opening may be formed only partially into the member 42. In any event, the openings are sized so that the wire frame shaft 16 is supported by the opening in the distal shaft receiving member 42. In any event, the roller engaging shafts 44 and 46 are constructed to engage shaft receiving roller bearings 48 and 50 carried internally at the proximal ends of the mini-rollers 34 and 36.

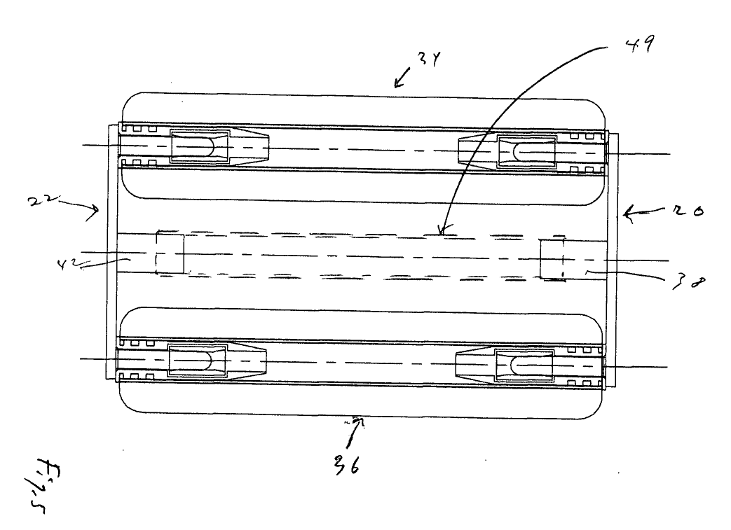

Referring to FIG. 4, one of the mini-rollers, e.g. 34, its internally carried shaft receiving roller bearings 30 and 48, are shown in more detail. The bearings themselves are not a part of the present invention and any equivalent bearing can be used, such as shown in previously referred to Patent Publication No. 2004/0237241. The mini-roller 34 includes a cylindrical member 52 which carries the roller material 54 externally and internally carries the shaft receiving roller bearings 30 and 48.

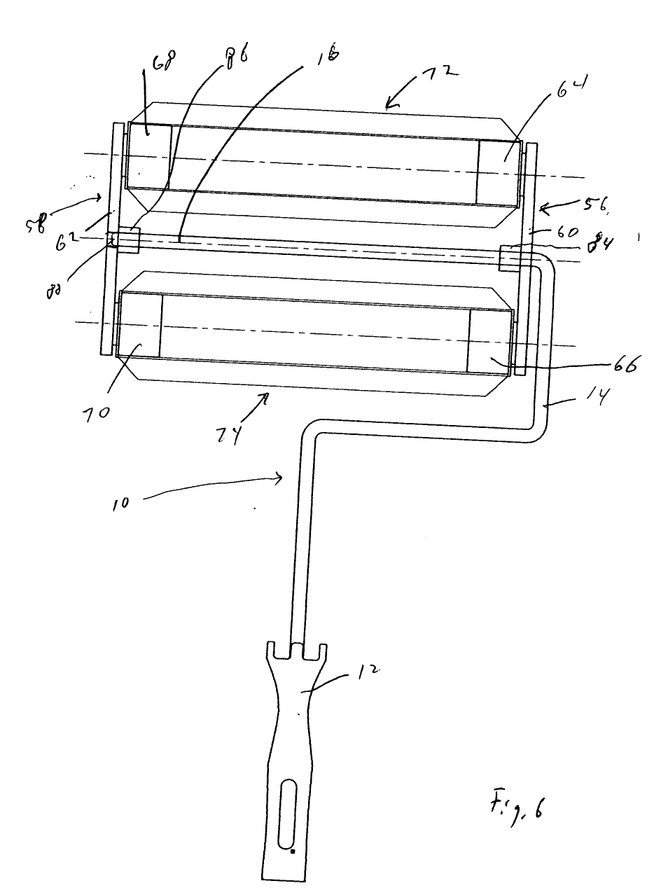

Referring to FIG. 5, the assembly of mini-rollers 34 and 36 is shown assembled with the proximal and distal brackets 20 and 22. In a modification, shown in shadow in FIG. 5, a connecting tube 49 can be inserted between, and carried by, the opposing shaft receiving members 38 and 42

The rollers 34 and 36 can be formed of any material that has sufficient nap or fuzzy surface, or porosity, to carry a desirable amount of paint. Any common paint roller material can be used for this purpose such as open cell polyurethane or other foam material having a low density, e.g., 4 to 10 Kg in weight per cubic meter. However, in accordance with a specific embodiment of the invention, one of the rollers, e.g., 36, is formed of a high density roller material, for example having about 50 to 64 Kg in weight per cubic meter. Material such as polyethylene ester foam of closed cell construction can be used, for the roller 36 material but one can use any other material that provides a smooth finish. In this way, the painter can avoid double rolling the surface by carrying sufficient paint on one of the rollers to cover a desirable surface area and using the other, high density, roller to provide a very smooth finish.

Each of the brackets 20 and 22, as well as the connecting tube and cylindrical member 52, can be made of plastic, such as polypropylene, polyethylene, nylon, acetal, Kapetal, or m27, or any of them can be made of metal, such as aluminum. The components are preferably made from a material that has some rigidity so that when pressure is applied to the assembly, it remains stable. The mini-rollers 34 and 36 are preferably about 6- 1/2 inches in length and 1/2 inch in diameter. The shaft receiving members 38 and 42 are constructed to hold the metal shaft of the paint roller frame tight enough so that it does not loosen, but yet the mounting plate 24 can swivel when the paint rollers 34 and 36 are contacting the surface to be painted.

Referring to FIG. 6, an assembly is shown consisting of the same roller frame 10 as in FIG. 1 having the handle 12 carrying a wire frame 14, terminating in the shaft 16. In this embodiment, as in the first embodiment, proximal and distal brackets, respectively 56 and 58 are provided, each consisting of a mounting plate 60 and 62. In this embodiment, each mounting plate 60 or 62 carries on its opposite ends a pair of rotatable paint roller engaging members 64, 66, 68, and 70, each of which frictionally engages a more or less standard paint roller, in this case a pair of such rollers 72 and 74.

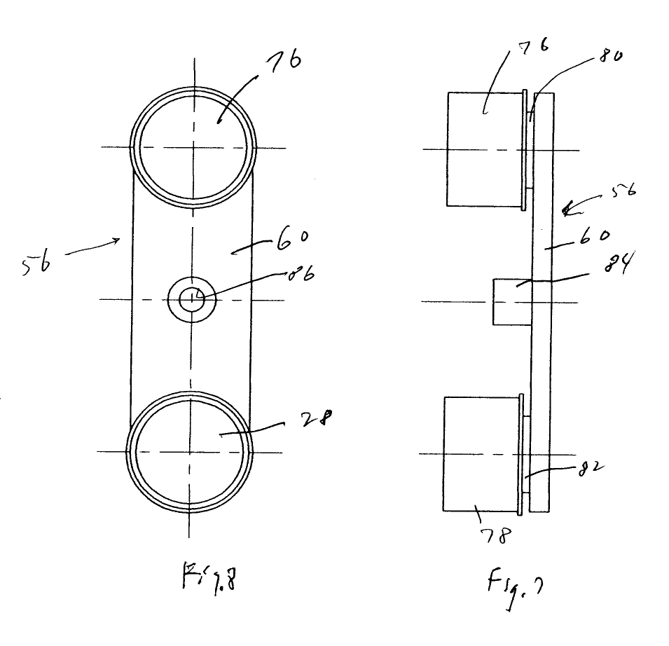

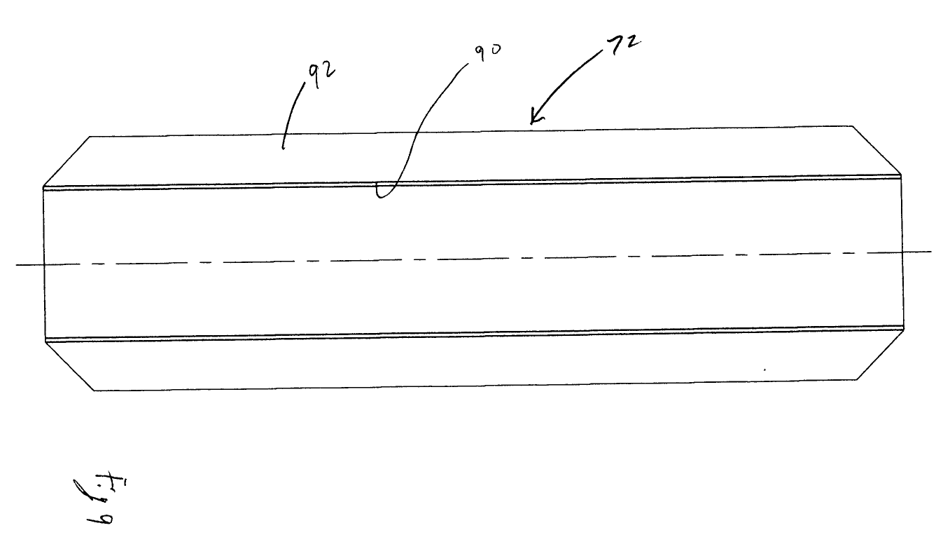

Referring to FIGS. 7 and 8, the proximal bracket 56 of this embodiment is shown. The bracket 56 in this embodiment is provided with a pair of roller engaging members 76 and 78 on opposite ends of the mounting plate 60 that extend normal to the mounting plate 60. The roller engaging members 76 and 78 are rotatable on the mounting plate 60 and carried by integral axle members, respectively 80 and 82. The rotatable roller engaging members 76 and 78 frictionally engaged the inner surfaces of the paint rollers 72 and 74 as shown in FIG. 6. The specific structure of the rotatable members 76 and 78 are not part of the present invention and can be any rotatable members used in the prior art, e.g. the flanged disks of U.S. Pat. No. 4,000,537.

The proximal bracket 56 contains a shaft receiving member 84 formed with an opening 86 there through, in the manner of the shaft receiving member 38 of FIGS. 1 and 2 so as to enable to wire frame shaft 16 to extend there through.

Referring back to FIG. 6, the distal bracket 58 is similarly formed but the shaft receiving member 86 alternatively can be formed with an opening that extends there through but terminates in an opening 88 through the mounting plate 62.

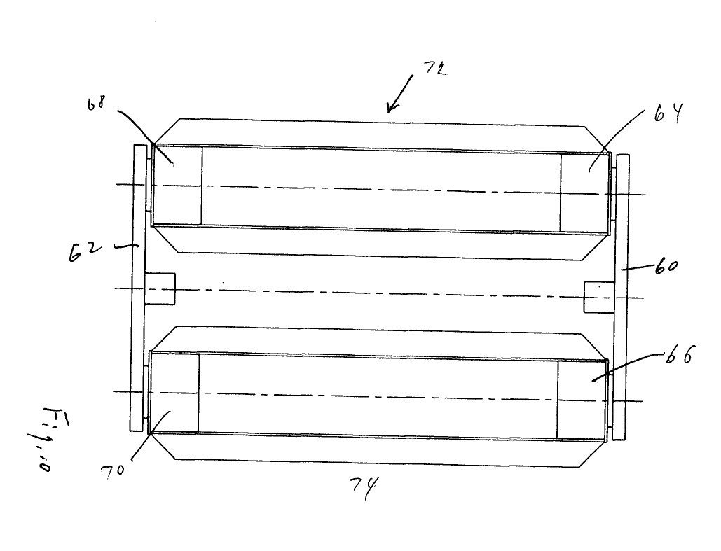

Referring to FIG. 9, a paint roller 72 is shown which is typical of widely available paint rollers of standard construction and which includes a roller 90 and paint roller surfacing material 92 disposed on the outer surface of the roller 90 for carrying paint or other material to be applied to a surface.

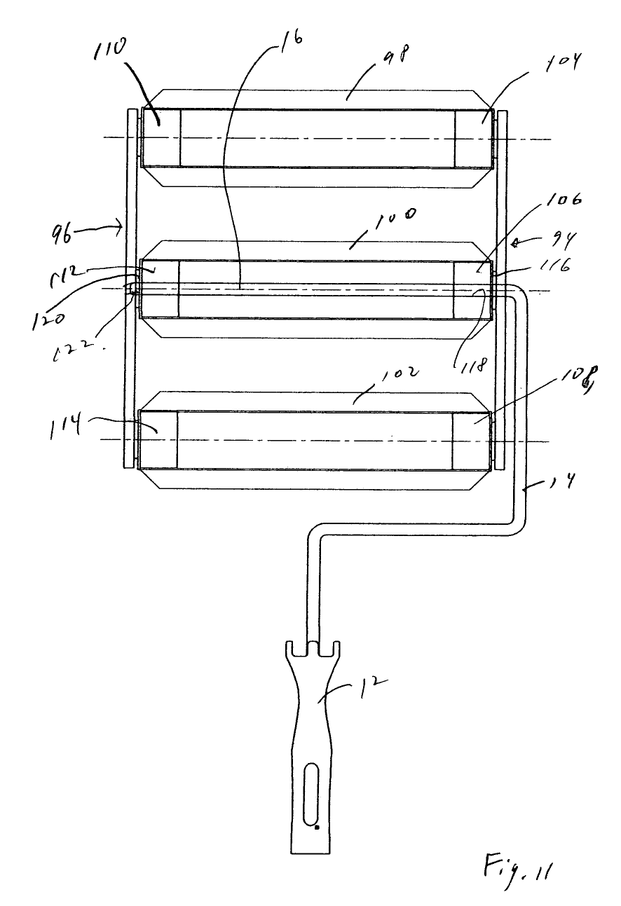

Referring to FIG. 10, an assembly of two paint rollers 72 and 74 is shown mounted on the rotatable members 64, 66, 68, and 70, rotatably carried on the mounting plate 60 and 62.

As with the paint roller assembly of FIGS. 1-5, the rollers 72 and 74 can be formed of any material that has sufficient nap or fuzzy surface, or porosity, to carry a desirable amount of paint. However, here also, in accordance with a specific embodiment of the invention, one of the rollers, e.g., 74, is formed of a high density roller material, as described with respect to the high density roller of FIG. 5, so that the painter can avoid double rolling the surface by carrying sufficient paint on one of the rollers to cover a desirable surface area and using the other high density, roller to provide a very smooth finish.

Referring to FIG. 11, still another embodiment is shown, which is similar to the embodiment of FIGS. 6 through 10 but in which proximal and distal brackets 94 and 96 carry three paint rollers of standard construction 98, 100 and 102. In this embodiment as well, the brackets 94 and 96 are constructed to be used with a standard paint roller frame including a handle 12 and a wire frame 14, terminating in a wire frame shaft 16. In this embodiment, each of the rotatable members 104, 106, 108, 110, 112, and 114 are constructed in the same manner as the rotatable members 64, 66, 68, and 70 of FIGS. 6-8, except that the centrally carried rotatable members 106 and 112 is constructed for two purposes. One of the purposes is to rotatably carry the third, center, roller 100 thereon. The other purpose is to engage the wire frame shaft 16 and in this regard the proximal axle 116 has an opening 118 there through of a dimension, and arrange, to pivotally receive the shaft 16 of the paint roller frame 14. The opposite axle 120, carrying the rotatable member 112, is also formed with an opening there through, as is the rotatable member, but which extends somewhat into the distal bracket 96, at 122.

1. A bracket for mounting one or more paint rollers to the shaft of a paint roller frame, comprising:
a mounting plate;
a pair of roller engaging members extending normal to the mounting plate on opposite ends thereof, each roller engaging member being formed to rollingly engage an end of a paint roller; and
a shaft engaging member between the pair of roller engaging members, having a shaft opening formed therein or there through of a dimension, and arranged, to pivotally receive the shaft of a paint roller frame.

2. An assembly comprising a pair of brackets of claim 1 in which the shaft-engaging member of each of the brackets has said shaft opening formed there through.

3. The bracket of claim 1 in which the roller engaging members are cylindrical shafts integral with the mounting plate, each having an outer diameter substantially the same as the paint roller frame shaft.

4. The bracket off claim 3 for use with one or two paint rollers having shaft receiving roller bearings carried internally on each end thereof.

5. The bracket of claim 1 in which the roller engaging members are rotatable on the mounting plate, each having an outer diameter substantially the same as the inner diameter of a paint roller whereby to frictionally engage the paint roller.

6. The bracket of claim 5 in which the shaft engaging member carries a roller engaging member rotatable on the mounting plate and having an outer dimension substantially the same as the inner diameter of a paint roller whereby to frictionally engage the paint roller

7. An assembly comprising a pair of brackets for mounting two paint rollers to the shaft of a paint roller frame, each paint roller carrying a shaft receiving roller bearing internally on each end thereof, each bracket comprising:
a mounting plate;
a pair of cylindrical roller engaging shafts integral with and extending normal to the mounting plate on opposite ends thereof, each having an outer diameter substantially the same as the diameter of the paint roller frame shaft for rollingly engaging the shaft receiving roller bearings; and
a shaft engaging member between the pair of roller engaging shafts, having a shaft opening formed there through of a dimension, and arranged, to pivotally receive the shaft of a paint roller frame.

8. An assembly comprising a pair of brackets for mounting two paint rollers to the shaft of a paint roller frame, each bracket comprising:
a mounting plate;
a pair of roller engaging members extending normal to, and rotatable on, the mounting plate on opposite ends thereof, each having an outer diameter substantially the same as the inner diameter of a paint roller whereby to frictionally engage the paint roller; and
a shaft engaging member between the pair of roller engaging members, having a shaft opening formed there through of a dimension, and arranged, to pivotally receive the shaft of a paint roller frame.

9. An assembly comprising a pair of brackets for mounting three paint rollers to the shaft of a paint roller frame, each bracket comprising:
a mounting plate;
a pair of roller engaging members extending normal to, and rotatable on, the mounting plate on opposite ends thereof, each having an outer diameter substantially the same as the inner diameter of a paint roller whereby to frictionally engage the paint roller; and
a paint roller and shaft engaging member between the pair of roller engaging members, extending normal to, and rotatable on, the mounting plate and having an outer diameter substantially the same as the inner diameter of a paint roller whereby to frictionally engage the paint roller, and having a shaft opening formed there through of a dimension, and arranged, to pivotally receive the shaft of a paint roller frame.

10. A multi paint roller assembly, comprising
first and second paint rollers; and
a pair of brackets for mounting the paint rollers to the shaft of a paint roller frame, each bracket comprising a mounting plate, a pair of roller engaging members extending normal to the mounting plate on opposite ends thereof, each roller engaging member being formed to rollingly engage an end of one of the paint rollers, and a shaft engaging member between the pair of roller engaging members, having a shaft opening formed therein or there through of a dimension, and arranged, to pivotally receive the shaft of a paint roller frame.

11. The multi paint roller assembly of claim 10 in which said first roller is formed with a surface material that has sufficient nap or a sufficiently low density or porosity to carry an amount of paint sufficient to cover a desired area of surface to be painted, and a said second roller is formed with a surface material of a sufficiently high density to provide a smooth finish to said surface area

12. The multi paint roller assembly of claim 11 in which said second roller is formed with surface material having density of about 50 to 64 Kg in weight per cubic meter.

13. The multi paint roller assembly of claim 12 in which said first roller is formed with surface material that has a density of 4 to 10 Kg in weight per cubic meter.
